(19) United States
(12) Patent Application Publication
(10) Pub. No.: US 2017/0353888 A1
(43) Pub. Date: Dec. 7, 2017

(54) Network Load Balancer

(71) Applicant: Nokia Solutions and Networks Oy, Espoo (FI)

(72) Inventors: Tomi Goran WECKSTROM, Hesinki (FI); Niko Markus SAVOLAINEN, Kerava (FI)

(73) Assignee: Nokia Solutions and Networks OY, Espoo (FI)

(21) Appl. No.: 15/536,221

(22) PCT Filed: Dec. 18, 2014
(86) PCT No.: PCT/EP2014/078352

§ 371 Date: Jun. 15, 2017

(51) Int. Cl. H04W 28/08

(52) U.S. Cl. CPC H04W 28/08

(57) ABSTRACT

In examples, a mobile network apparatus, a computer program and a method is discussed, including at least one processor, and at least one memory storing program instructions that, when executed by the at least one processor, cause to: Receive a create request for requesting data connectivity. Based on the create request, perform a static load balancing. Based on the static load balancing, perform a caching relating to a dynamic load balancing and perform the dynamic load balancing. A load balancing method may be scalable with a grace period.

### BACKGROUND

A mobile network gateway is an aggregation point for millions of sessions in packet core and in an evolved packet core EPC. A general packet radio service GPRS gateway support node GGSN, a network element in packet core, serving gateway S-GW, and packet data network PDN gateway P-GW, in EPC are responsible for providing mobile gateway services for user equipment UE, such as a tablet, a mobile phone, laptop, or other mobile computing device, etc.

In general, mobile gateways are responsible of subscriber management, session management, bearer management, accounting, routing and forwarding, quality of service QoS, etc. In a traditional use, a single gateway network element must be capable of handling millions of UE sessions and bearers with hundreds of Gbps throughput. Long term evolution LTE, with modern handsets introduces increasing amount of signaling events and user data for mobile gateways.

An increasing demand for a signaling transaction support and a user data forwarding capacity causes a mobile gateway to require more hardware in order to fulfil the needs for the modern networks. While capacity needs are increasing, there is also pressure to introduce mobile gateway in a virtualized environment. A virtualized mobile gateway will not be as dense from a hardware utilization point of view. However, the virtualized mobile gateway shall require more units to achieve the same capacity and performance compared to embedded or specialized solutions.

With a virtualized gateway solution, it is possible to introduce new mobile gateway virtual machines VMs. A new VM may be spawned the network element itself. Neighboring elements need to take into account (e.g. scale in) the new VM in use. The 3^{rd} Generation Partnership Project 3GPP has some mechanisms to handle network element scale out or scale in operations.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In one example, a mobile network apparatus is discussed, comprising: at least one processor, and at least one memory storing program instructions that, when executed by the at least one processor, cause the apparatus to receive a create request for requesting a data connectivity. Based on the create request, perform a static load balancing. Based on the static load balancing, perform a caching relating to a dynamic load balancing and perform the dynamic load balancing.

In another examples a method and a computer program product has been discussed along with the features of the mobile network apparatus.

Many of the attendant features will be more readily appreciated as they become better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates an example of a mobile architectural model;

FIG. 2 illustrates a gateway cloud, in accordance with an illustrative example;

FIG. 3 illustrates load balancing, in accordance with an illustrative example;

FIG. 4 illustrates load balancer scalability, in accordance with an illustrative example; and

FIG. 5 is a block diagram of one illustrative example of the gateway apparatus.

Like references are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples.

References and abbreviations of the examples:

DNS domain name system

EPC evolved packet core

ECMP equal cost multipath

Gbps giga (1×10̂9) bits per second

GGSN general packet radio service GPRSgateway support node

GW gateway

GWC gateway cloud

IE information element

IMSI international mobile subscriber identity

LB load balancer

LTE long term evolution

NFV network function virtualization

NFVO network function virtualization orchestrator

NFV-MANO network function virtualization management and orchestration

P-GW packet data network PDN gateway

QoS quality of service

S-GW serving gateway

UE user equipment

VM virtual machine

VNF virtualized network function

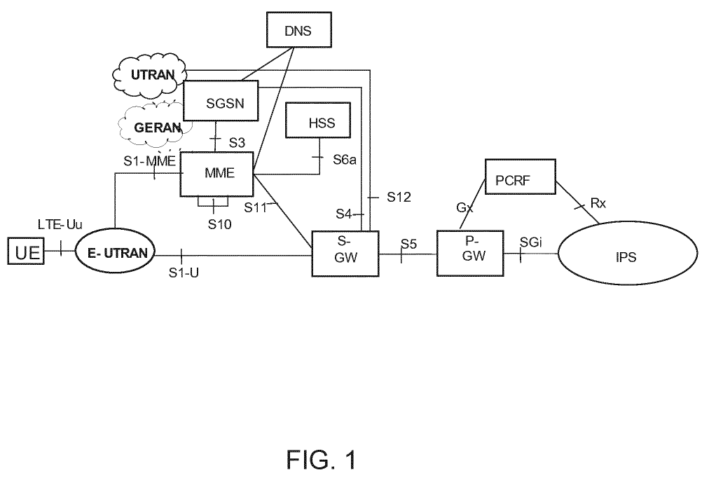

FIG. 1 illustrates an example of a 3GPP mobile architectural model. Although the present examples may be described and illustrated herein as being implemented in GGSN, S-GW and P-GW gateway types, these are only examples of gateway apparatuses and not limitations. As those skilled in the art will appreciate, the present examples are suitable for application in a variety of different types of gateway apparatuses. Furthermore, present examples are applicable for all mentioned gateway types and consequently the term mobile network apparatus later in the document covers all gateway types. Related examples and figures about specific mobile gateway environment are applicable also for other architectures.

In the example, load balancing for incoming sessions may be static and dynamic. A static load balancing may be based on static information. For example, features of the network, which remains static independently of the load or available resource. An example of static information may be an international mobile subscriber identity IMSI. A dynamic load balancing may be based on available resources. For example, available resources may depend on the amount of UEs connected to the network or networks capability, etc.

When mobile gateway resources are increased by scaling out a new GW VM, the new GW VM does not have subscribers or load; whereas the existing network nodes, for example operating GW VMs, are highly loaded. For example, the existing network nodes triggered the scale out in the first place. To benefit from spawning a new GW VM, the new GW VM is configured to operate as the least loaded VM for incoming UEs.

Additionally, after spawning the new GW VM, load balancing functionality is configured to locate all sessions of a single subscriber, which is for example defined by IMSI, to the same gateway node in a S-GW, and preferably also in a P-GW as much as possible, due to requested services.

An example intends to bring dynamic, scalable and access protocol independent load balancer LB VMs to a gateway cloud GWC. The example defines a load balancing method. The example also defines how to scale out or scale in VMs inside a LB. The LB is configured to select least a loaded GW VM for a new PDN connection. The LB is configured to hide the gateway scale out or scale in operations from the surrounding network. The LB may be externally visible via a single floating address. The LB may scale out, or scale in, independently. The LB may remain fully functional during its own scale out, or scale in operations.

An example relates to a static load balancing. According to the example, the LB is configured to select a LB VM statically. A certain LB VM is selected from various available LB VMs. The static selection is performed based on static information. Static information is received from a create request. The create request may be received from a UE. For example, an IMSI may be used as the static information. The create request is forwarded to a corresponding LB VM, which is configured to provide a centralized place for further processing.

An example relates to dynamic load balancing. The selected LB VM is further configured to perform a dynamic load balancing. The LB is also configured to select a GW VM dynamically, for example, a least loaded GW VM. A certain GW VM is selected from various available GW VMs. The selected LB VM is also configured to perform caching, for example check a cache for a previous dynamic load balancing decision and also store new decisions to an internal cache. The cached decision is used for protocol retransmission and handovers with multiple PDN connection to retrieve the same load balancing decision. Consequently, previously stored selection of the LB VM and GW VM can be stored and used later, if the connection details are identical or similar.

FIG. 1 illustrates further standardized signaling interfaces, LTE-Uu, S1-MME, S1-U, S10, S3, S11, S6a, S4, S12, S5, Gx, SGi, Rx, with respect to the network entities.

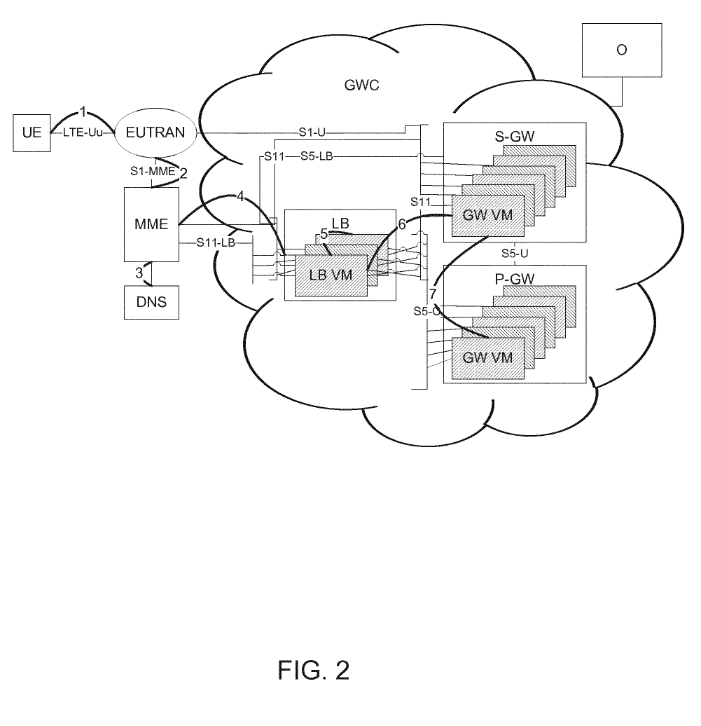

FIG. 2 shows an example of a gateway cloud, GWC. At 1, a UE requests PDN connectivity. The UE requests the PDN connectivity from a radio, into which the UE is attached. At 2, an MME, which is in an appropriate location, is selected to serve the UE. At 3, the MME performs a DNS query. The DNS query is used to obtain the IP addresses of the S-GW and P-GW, which provides the access point for the UE. The DNS query result may include only a floating address of the gateway. At 4, the MME sends a create request. The MME sends the create request to the LB. The MME may send the create request to the LB via a floating interface. At 5, the receiving LB VM performs a static load balancing. The static load balancing is performed to find out an appropriate LB VM for the create request, for example, the LB VM which corresponds most with the static information (for example based on IMSI), can be selected. At 6, the selected LB VM performs a dynamic load balancing. The selected LB VM performs dynamic load balancing to further select a least loaded GW VM. For example, a GW VM may be selected which has the most capacity or best performance for communications. At 7, the S-GW forwards the create request to a P-GW selected by the MME. The S-GW and P-GW comprises the respective GW VMs. The P-GW S5/S8 address can be also a floating address. However, in this example the P-GW GW VM is not load balanced via an LB in order to simplify the example.

FIG. 2 illustrates further standardized signaling interfaces, LTE-Uu, S1-MME, S11-LB, S11, S1-U, S5-U, S5-C, with respect to the network entities.

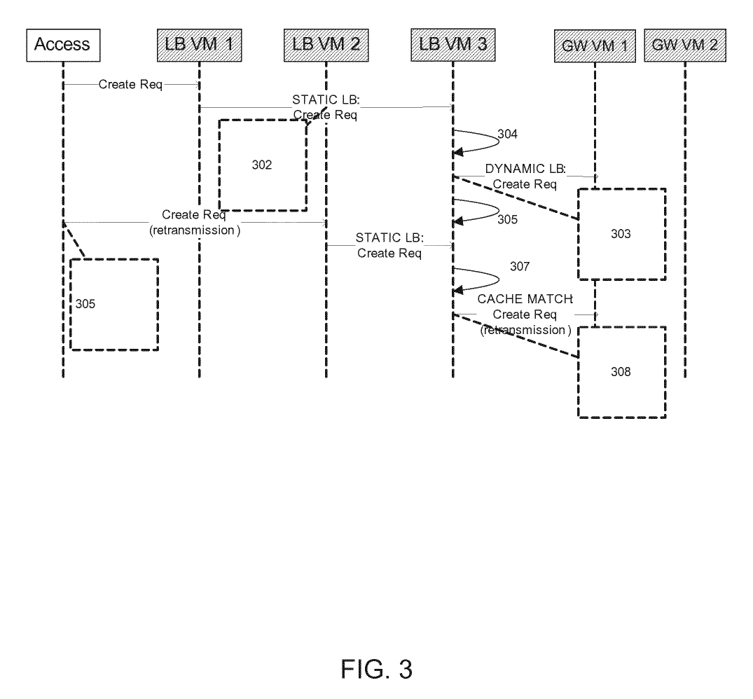

An example of a load balancing of a GW is depicted in FIG. 3. A load balancing method is shown in FIG. 3. The method is based on phased load balancing with caching inside the LB.

At Create Req of FIG. 3, a create request is received. At 302, a static load balancing is processed. The static load balancing is performed between the LB VMs. The step 302 is performed in order to have a single centralized point for a dynamic load balancing and for a caching for the specific UE. The static load balancing is needed, because nothing guarantees that routers are always selecting same path, for example equal cost multipath ECMP, for all messages. The static load balancing is performed based on static information, which is obtained from the create message, for example IMSI. By that way, a signaling related to the same UE, like retransmissions or handovers, can be handled by the same statically selected LB VM.

Next an actual gateway node is selected. A GW VM is selected at 303. GW VM is selected based on dynamic load information. Dynamic load information is received from GW VMs. First check is made whether a cache match exists. The caching helps to ensure that similar connections obtain the GW VM based on the stored decision. For example, the caching helps to guarantee the same load balancing decisions for all sessions of the UEs. At 304, in case there is no cache match for the request, the dynamic load balancing is performed at 303. In case there is a cache match at 307, the request is forwarded to the GW VM found from cache at 308 and at CACHE MATCH Create Req (retransmission) as in FIG. 3. Static load balancing and caching of the decision in the cache prevents a need for a centralized or a distributed database.

In FIG. 3, at 304 it is determined that there is no cache match. Now the dynamic load balancing is performed at 303. The cache is updated with the decision at 305. In the example FIG. 3, a retransmission of the create request is shown at 305 and at Create Req (retransmission). Retransmission can go to whatever LB VM. At STATIC LB:Create Req, the static load balancing is performed. At 307, a cache match in found. There is no need for a dynamic load balancing, because this decision is already done at 303. Consequently, the details of this decision can be utilized directly at 308 and at CACHE MATCH Create Req (retransmission).

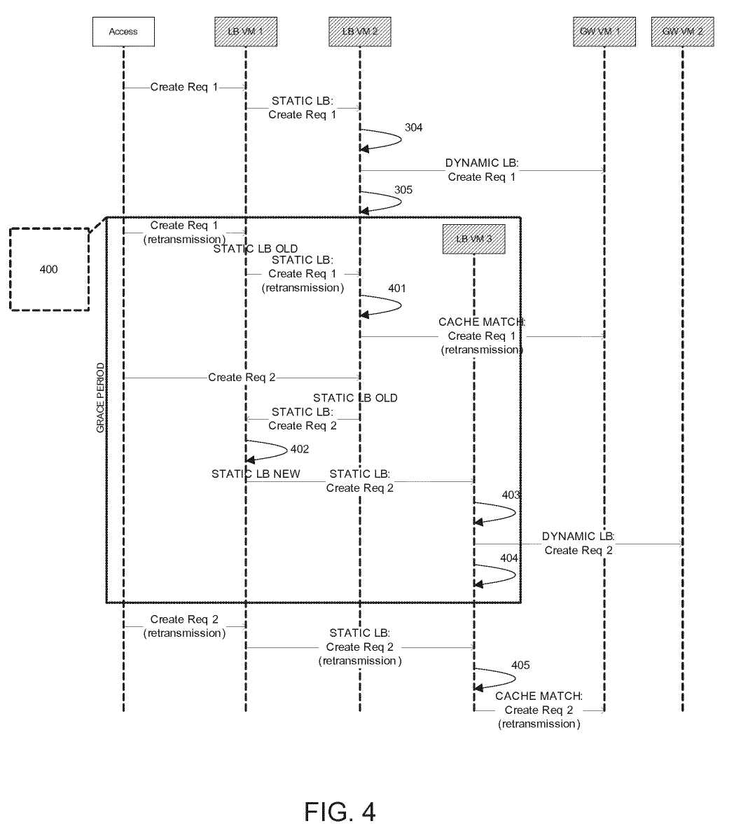

FIG. 4 illustrates an example of a load balancer scalability. In the example, the steps Create Req 1, STATIC LB Create Req 1, 304, 305 and DYNAMIC LB: Create Req 1, may be conducted similarly as discussed for the example of FIG. 3. However, a static load balancing may cause an issue, wherein a new LB VM cannot be scaled out or scaled in immediately. A change of a static LB algorithm breaks a retransmission support for ongoing requests and handovers. In order to guarantee the best possible service, there should be a grace period 400, before a static LB method can be changed. A grace period 400 is configured to guarantee that a static load balancing method is changed in a controlled manner. The grace period 400 may be required in all LB scaling operations, for example scale out or scale in.

According to an example, a grace period 400 is started, when a new LB VM is spawned, for example added, removed to or from the LB. In the example LB VM 3 is spawned to the network. Length of the grace period 400 can be configurable. For example, the length may be greater or equal to the time defined by GTP N3/T3 in access side for create requests. By having the same time, it can be guaranteed, that all retransmissions for create requests, which are sent just before a grace period is started, can be delivered to correct LB VM (not shown in FIG. 4).

The example of FIG. 4 is illustrated for a LB scale out operation. In the example of FIG. 4, a new LB VM 3 is spawned to the network. The same procedure in general applies also for a LB scale in operation, for example, when a LB VM is dismissed. New create requests initiated, for example the steps Create Req 1 (retransmission) and Create Req 2 in the FIG. 4, while the grace period 400 is already active, shall be treated with an old and a new static method, steps STATIC LB OLD and STATIC LB NEW in FIG. 4. The old method, step STATIC LB OLD, is needed to forward message to the LB VM, which checks the cache in the step 401. When there is a cache match, the GW VM 1 can be selected directly, at CACHE MATCH: Create Req 1 (retransmission) in FIG. 4. When there is no cache match at 402, the request is new and shall be statically balanced with the new static method at STATIC LB NEW in FIG. 4. In this case, the cache match check with respect to the dynamic load balancing is performed at 403, indicating no match. The dynamic load balancing is performed at DYNAMIC LB Create Req 2 as in FIG. 4, and the decision is updated to cache at 404.

FIG. 4 illustrates also the create requests outside the grace period 400. The create request is processed at Create Req 2, and the static load balancing for this at STATIC LB Create Req 2. Now a cache match with respect to the dynamic load balancing is found at 405, and the dynamic load balancing is performed directly with GW VM 2 at CACHE MATCH Create Req 2 (retransmission) in FIG. 4.

The LB functionality may be configured to operate as an independent network element. The LB may be able to work in a multi-vendor environment and all access interfaces are specified by 3GPP. The same LB can be used for local interfaces, for example S11/S4/S5/Gn, within an operator's own public land mobile network PLMN. The same LB can also be used for an inter-PLMN interface, for example S8/Gp, to provide a load balancing roaming connectivity.

The following examples relate to GTP specification related issues, when bringing an additional network element between an access network and a gateway.

An example of distribution of the load information. To make load balancing decision based on a load of the GW VMs, the LB needs load information from all GW VMs. For example, 3GPP Release 12 specifies load information IE to be used in whatever GTPv2 message. The LB can fetch that information from a response message. Currently, 3GPP has not defined similar functionality for GTPv1. However the LB may be protocol independent by using new messages for the load information distribution.

According to an example, the source address of the response message shall be the same than destination address in the request message. Because a gateway is not having the floating address at all, a response message shall be sent via a LB in order have a correct address in the response. This requires the LB to act as a proxy, which needs to allocate a sequence number towards the gateway and switch it to the original again for the response towards the access side. GWs can deliver their own load information among in the response messages. The Re112 GTPv2 specification already defines that functionality for a S-GW and a P-GW, which may be utilized.

According to an example, handling of recovery IE may be as follows. Recovery IE in the create request is not coupled to the source address of the message. Instead, it is coupled to the address of the control plane tunnel, which is inside the message. The gateway starts a path management, for example echoing, for this address and also checks recovery IE against it. Consequently, a LB can transparently deliver recovery IE to the gateway.

Furthermore, a LB may be able to distribute received load information from GW VMs between LB VMs.

According to an example, a LB is informed about the presence of GW VMs, for example for the scale out or the scale in operation with the GW VMs.

This is externally visible functionality and in order to have a multi-vendor LB network element, functionality may be based on standards. There can be many ways to accomplish this and merely for the sake of illustration, an example is disclosed.

A LB may have a local configuration for GW VM access IP addresses. When a new GW VM is spawned to the cloud, a cloud orchestrator can apply the IP address of the newly spawned GW VM to the LB configuration, for example LB VMs. In the network function virtualization management and orchestration NFV-MANO architectural framework, the network function virtualization orchestrator NVFO applies configurations to VMs, for example virtualized network function VNFs, via a virtualized network function manager VNFM. When a GW VM is removed, the GV VM access IP address is removed from the LB configuration.

GW VMs may have a local configuration about the LB access interfaces. When a new GW VM is spawned to the cloud, the GW VM can start reporting periodically its own load, and a LB learns a new GW VM. This option is applicable, if there will be a new message specified for a load reporting, for example as discussed above. In case the load reporting is based on a current GTP message, optionally the GW VM may send an echo request message to an LB access interface. This may violate the specified echoing standard. Removing of the GW VM is determined based on stopped periodical load reporting.

In the examples, the UE may be in a form of a smartphone, and as discussed other mobile devices may be used equivalently, such as tablet computers, netbook computers, laptop computers, desktop computers, processor-enabled televisions, personal digital assistants (PDAs), touchscreen devices connected to a video game console or set-top box, or any other computing device that has a mobile network connection.

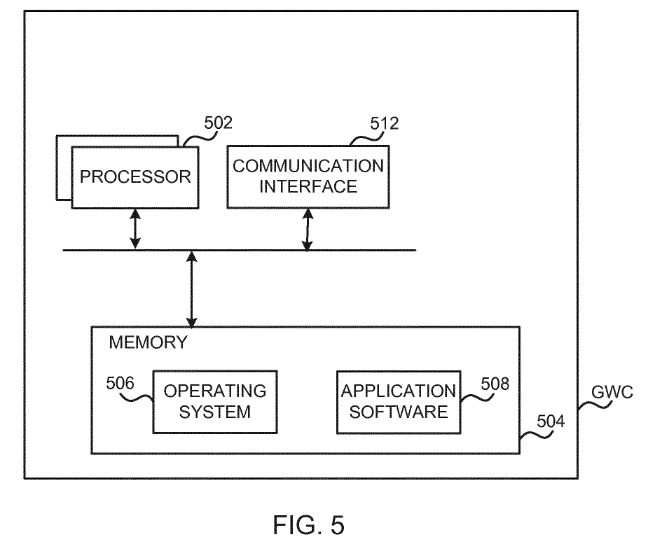

FIG. 5 illustrates example components of a mobile network apparatus, for example a GWC as in FIG. 5, FIG. 4, FIG. 3 and FIG. 2, which may be implemented as any form of a computing and/or electronic device. The mobile network apparatus of FIG. 5 may act as the gateway comprising at least part of the LB VMs and GW VMs. The mobile network apparatus comprises one or more processors 502 which may be microprocessors, controllers or any other suitable type of processors for processing computer executable instructions to control the operation of the apparatus. Platform software comprising an operating system 506 or any other suitable platform software may be provided at the apparatus to enable application software 508 to be executed on the device.

Computer executable instructions may be provided using any computer-readable media that is accessible by the apparatus. Computer-readable media may include, for example, computer storage media such as memory 504 and communications media. Computer storage media, such as memory 504, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 504) is shown within the apparatus it will be appreciated that the storage may be distributed or located remotely and accessed via a network or other communication link (e.g. using communication interface 512).

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), Graphics Processing Units (GPUs).

The term ‘computer’, ‘computing-based device’, ‘apparatus’ or ‘mobile network apparatus’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions. The software can be suitable for execution on a parallel processor or a serial processor such that the method steps may be carried out in any suitable order, or simultaneously.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network).

Any range or device value given herein may be extended or altered without losing the effect sought. Also any example may be combined to another example unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one example or may relate to several examples. The examples are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. An mobile network apparatus comprising:
at least one processor, and
at least one memory storing program instructions that, when executed by the at least one processor, cause the apparatus to:
receive a create request for requesting data connectivity;
based on the create request, perform a static load balancing; and
based on the static load balancing, perform a caching relating to a dynamic load balancing and perform the dynamic load balancing.

2. The mobile network apparatus of claim 1, wherein the at least one memory store program instructions that, when executed, cause the apparatus to establish communications between an internet protocol service provider and a user equipment based on the performed static load balancing, the caching and the dynamic load balancing.

3. The mobile network apparatus of claim 1, wherein based on the performed static load balancing, the at least one memory store program instructions that, when executed, cause the apparatus to select a load balancer virtual machine corresponding to the create request, and wherein the load balancer virtual machine is selected from a plurality of load balancer virtual machines.

4. The mobile network apparatus of claim 1, wherein the create request comprises static information, and the static load balancing is configured to be performed based on the static information.

5. The mobile network apparatus of claim 4, wherein the static information comprises features of the network, which remain static independently of the load or available resource.

6. The mobile network apparatus of claim 5, wherein the static information comprises international mobile subscriber identity.

7. The mobile network apparatus of claim 1, wherein based on the performed dynamic load balancing, the at least one memory store program instructions that, when executed, cause the apparatus to select a gateway virtual machine from a plurality of gateway virtual machines.

8. The mobile network apparatus of claim 7, wherein a least loaded gateway virtual machine is configured to be selected.

9. The mobile network apparatus of claim 3, wherein the selected load balancer virtual machine is configured to select a least loaded gateway virtual machine.

10. The mobile network apparatus of claim 1, wherein the dynamic load balancing is based on available resources of a plurality of gateway virtual machines.

11. The mobile network apparatus of claim 1, wherein mobile network apparatus comprises a load balancer and a gateway.

12. The mobile network apparatus of claim 1, wherein the load balancer comprises a plurality of load balancer virtual machines, and
wherein the gateway comprises a plurality of gateway virtual machines.

13. The mobile network apparatus of claim 12, wherein the plurality of gateway virtual machines comprises a plurality of serving gateways and a plurality of packet data network gateways.

14. The mobile network apparatus of claim 1, further comprising a cache configured to the caching and further configured to store decisions of dynamic load balancing, and the performed dynamic load balancing is compared to the stored decisions.

15. The mobile network apparatus of claim 14, wherein in case of no correspondence, the cache is configured to be updated based on the performed dynamic load balancing.

16. The mobile network apparatus of claim 14, wherein in case of correspondence, the performed dynamic load balancing is based on the stored decision.

17. The mobile network apparatus of claim 1, further comprising a grace period, which is configured to start when a change in load balancer virtual machines is configured to the mobile network apparatus, and wherein the grace period is configured to check whether the static load balancing is based on the changed load balancer virtual machine.

18. A computer-readable storage medium comprising executable instructions for causing at least one processor of a computing apparatus to perform operations comprising:
receive a create request for requesting data connectivity;
based on the create request, perform a static load balancing; and
based on the static load balancing, perform a caching relating to a dynamic load balancing and perform the dynamic load balancing.

19. A method, comprising:
receiving a create request for requesting data connectivity;
based on the create request, performing a static load balancing; and
based on the static load balancing, performing a caching relating to a dynamic load balancing and performing the dynamic load balancing.
